(19) United States
(12) Patent Application Publication
(10) Pub. No.: US 2019/0228159 A1
(43) Pub. Date: Jul. 25, 2019

(54) TECHNOLOGIES FOR FILTERING MEMORY ACCESS TRANSACTIONS RECEIVED FROM ONE OR MORE ACCELERATORS VIA COHERENT ACCELERATOR LINK

(71) Applicant: Intel Corporation, Santa Clara, CA (US)

(72) Inventors: Anna Trikalinou, Hillsboro, OR (US); Krystof Zmudzinski, Forest Grove, OR (US); Reshma Lal, Hillsboro, OR (US); Luis S. Kida, Beaverton, OR (US); Pradeep M. Pappachan, Hillsboro, OR (US); Raghunandan Makaram, Northborough, MA (US); Siddhartha Chhabra, Portland, OR (US); Vincent R. Scarlata, Beaverton, OR (US)

(21) Appl. No.: 16/369,279

(22) Filed: Mar. 29, 2019

(51) Int. Cl. G06F 21/57

(52) U.S. Cl. CPC G06F 21/575; G06F 2221/034

(57) ABSTRACT

Technologies for filtering transactions includes a compute device, which further includes an accelerator device and an I/O subsystem having an accelerator port. The I/O subsystem is configured to determine whether to enable a global attestation during a boot process of the compute device, receive a transaction from the accelerator device connected to the accelerator port via a coherent accelerator link, and filter the transaction based on a determination of whether to enable the global attestation.

### BACKGROUND

Trust domains provide isolation for virtual machines without including a virtual machine monitor (VMM) in a trusted code base (TCB) of the trust domain. Memory is protected using multi-key total memory encryption (MKTME). Each trust domain has its own Key ID used by MKTME to protect memory contents from other trust domains and the VMM. Hardware in a system-on-a-chip (SoC) enforces the protection. Generally, trust domain systems do not allow I/O devices to access trust domain-protected memory.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a compute device having an I/O subsystem for filtering memory access transactions between one or more accelerators connected to an accelerator port of the I/O subsystem and a trust domain;

FIG. 2 is a simplified block diagram of at least one embodiment of an environment of the I/O subsystem of FIG. 1; and

FIGS. 3-5 are a simplified flow diagram of at least one embodiment of a method for filtering trust domain memory access requests received from an accelerator connected to the accelerator port of the I/O subsystem that may be executed by the I/O subsystem of the compute device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

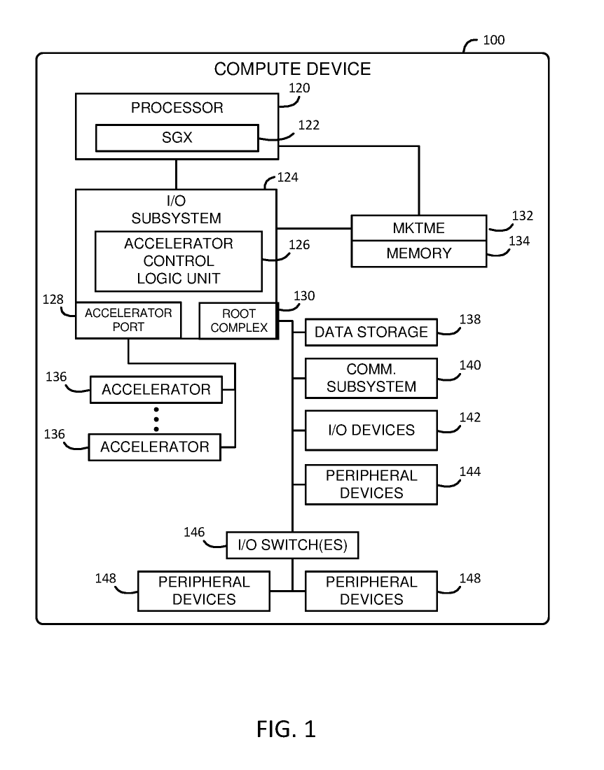

Referring now to FIG. 1, an illustrative compute device 100 for filtering memory access transactions between one or more accelerators 136 connected to an accelerator port 128 of an I/O subsystem 124 and a trust domain (TD) is shown. In order to perform a secure I/O with the trust domain, the trust domain may authenticate an I/O device and determine a reliable device ID for the I/O device. The trust domain may program enforcement hardware (e.g., the accelerator control logic unit 126 (e.g, the IOMMU), root complex, or the device itself) with a binding between the trust domain and the device ID and memory access permissions for a trust domain memory. As such, when the I/O device generates direct memory access (DMA) transactions to access the trust domain memory, the enforcement hardware may enforce the binding between the trust domain and the device ID as well as the memory access permissions. If the transaction is allowed, the trust domain memory is accessed securely using multi-key total memory encryption (MKTME) support. It should be appreciated that a similar technique may be applied to other types of data transactions (e.g., memory-mapped I/O (MMIO) or cache access transactions) generated by the I/O device.

In use, as described further below, the I/O subsystem 124 may enable or disable a global attestation during a booting process of the compute device 100 to filter direct memory access (DMA) transactions received from one or more I/O devices (e.g., accelerator devices 136) that are connected to the accelerator port 128 of the I/O subsystem 124. By controlling the global attestation, the I/O subsystem 124 may allow or block a transaction between a trust domain and the accelerator device 136 connected to the accelerator port 128. In the illustrative embodiment, the global attestation is disabled as a default unless it is enabled during the booting process. If the global attestation is disabled, the I/O subsystem 124 may block all transactions received via the accelerator port 128 that are requesting to access a trust domain memory. In other words, the I/O subsystem 124 allows accesses via the accelerator port 128 to a shared memory when the global attestation is disabled. Alternatively, if the global attestation is enabled during the booting process, the I/O subsystem 124 may allow transactions received from one or more accelerator devices 136 that are trusted by a trust domain to access the trust domain memory securely using the MKTME support.

The compute device 100 may be embodied as any type of device capable of performing the functions described herein. For example, the compute device 100 may be embodied as, without limitation, a computer, a laptop computer, a tablet computer, a notebook computer, a mobile compute device, a smartphone, a wearable compute device, a multiprocessor system, a server, a workstation, a distributed compute device, a disaggregated compute device, and/or a consumer electronic device. As shown in FIG. 1, the illustrative compute device 100 includes a processor 120, an I/O subsystem 124 having an accelerator control logic unit 126, a memory 134, a communication subsystem 140, one or more accelerators 136 connected to an accelerator port 128 of the I/O subsystem 124, and one or more I/O devices 142 connected to a root complex 130 of the I/O subsystem 124. Additionally, in some embodiments, one or more of the illustrative components may be incorporated in, or otherwise form a portion of, another component. For example, the memory 134, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. As shown, the processor 120 illustratively includes multi-key total memory encryption (MKTME) support 132. The MKTME 132 may encrypt data that is transmitted to the memory 134 for storage and decrypt encrypted data retrieved from the memory 134.

The MKTME support 132 allows the processor 120 to transparently encrypt the contents of the memory 134. The MKTME support 132 maintains a table or other internal, protected structure with multiple encryption keys, which are used to encrypt and decrypt data as it is stored to and read from the memory 134, respectively. The encryption keys are illustratively 128-bit AES XTS keys although may be embodied as any symmetric, asymmetric, or other encryption key. The encryption key may be selected by the MKTME support 132 on a per-page basis, for example based on a key identifier included in one or more otherwise unused upper bits of the physical memory page address for a particular memory access. In those embodiments, an operating system, virtual memory monitor, or other supervisory component of the compute device 100 may control access to particular memory pages by configuring one or more page tables and/or extended page tables with the appropriate key identifiers. MKTME keys may be generated by the MKTME support 132, in which case they are not disclosed outside of the processor 120, or may be supplied by software. In some embodiments, the MKTME support 132 may include support for Intel® Trusted Domain Extensions (TDX). With TDX, the MKTME support 132 may accept an external “domain” key, also called a “user” or “tenant” key. The processor 120 may also use a default key that is self-generated to protect memory used by MKTME and Intel SGX as well as Intel TDX.

The memory 134 may be embodied as any type of volatile or non-volatile memory or data storage capable of performing the functions described herein. In operation, the memory 134 may store various data and software used during operation of the compute device 100 such as operating systems, applications, programs, libraries, and drivers. As described above, in some embodiments, part or all of the contents of the memory 134 may be encrypted or otherwise protected from unauthorized disclosure using the MKTME support 132 of the processor 120. Illustratively, the memory 134 is communicatively coupled to the processor 120 via the I/O subsystem 124, which may be embodied as circuitry and/or components to facilitate input/output operations with the processor 120, the memory 134, and other components of the compute device 100.

For example, the I/O subsystem 124 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations. In some embodiments, the memory 134 may be directly coupled to the processor 120, for example via an integrated memory controller hub or a data port. The I/O subsystem 124 may further include a sideband network, secure fabric, or other secure routing support. The secure routing support may include hardware support to ensure I/O data cannot be misrouted in the I/O subsystem 124 under the influence of rogue software. Additionally, in some embodiments, the I/O subsystem 124 may form a portion of a system-on-a-chip (SoC) and be incorporated, along with the processor 120, the memory 134, and other components of the compute device 100, on a single integrated circuit chip. The compute device 100 may include a data storage device (not shown), which may be embodied as any type of device or devices configured for short-term or long-term storage of data such as, for example, memory devices and circuits, memory cards, hard disk drives, solid-state drives, non-volatile flash memory, or other data storage devices.

As shown, the compute device 100 further includes an accelerator control logic unit 126. In the illustrative embodiment, the accelerator control logic unit 126 is incorporated in the I/O subsystem 120 as a portion of integrated circuit chip. The I/O subsystem 124 includes one or more ports, such as one or more PCI express ports 130, one or more accelerator ports 128 (e.g., an Intel Accelerator Link (IAL) port), or other ports. Each port may be coupled to one or more accelerators and/or other I/O devices, and the accelerator control logic unit 126 is configured to filter transactions received from the accelerators and/or other I/O devices.

The accelerator control logic unit 126 may be embodied as any hardware controller(s), component(s), or other circuitry capable of performing the functions described herein. In particular, the accelerator control logic unit 126 may filter data transactions generated by one or more accelerators 136 connected to the accelerator port 128 of the I/O subsystem 124 of the compute device 100. To do so, the accelerator control logic unit 126 may be programmed statically by a trusted agent during a booting process of the compute device 100 to enable or disable a global attestation to block or allow transactions received from one or more accelerator devices 136 connected to the accelerator port 128. In the illustrative embodiment, the global attestation is disabled as a default unless it is enabled during the booting process. If the global attestation is disabled, the accelerator control logic unit 126 is configured to block all transactions received through the accelerator port 128 that are requesting to access a trust domain memory. To do so, the accelerator control logic unit 126 may further be configured to determine whether a memory address of the memory access request is to a protected memory of a trust domain or a shared memory based on a key identifier (KID) indicated in the transaction. In other words, the accelerator control logic unit 126 is configured to allow accesses to a shared memory when the global attestation is disabled. If the global attestation is enabled during the boot process, the accelerator control logic unit 126 is configured to allow all transactions received from one or more accelerator devices 136. For example, the accelerator control logic unit 126 may allow transactions received from one or more accelerator devices 136 that are requesting to access a shared memory. Additionally, the accelerator control logic unit 126 may allow transactions received from one or more accelerator devices 136 that are trusted by a trust domain to access the trust domain memory securely using the MKTME support.

In some embodiments, filtering may be performed for Intel Accelerator Link (IAL) devices, including secure use of IAL.mem and IAL.cache. In such embodiments, the accelerator control logic unit may be included in a SoC's control module, MS2IAL, for cache accesses. As discussed above, this accelerator control logic unit may be programmed statically by a trusted agent during boot. As described further below, the filter logic may drop all cache accesses where the KID of a DMA transaction falls within the private KID reserved for trust domains. Alternatively, the MS2IAL module may be programmed dynamically after boot. The MS2IAL module is configured to allow those trust domain memory accesses whose KIDs are programmed in the accelerator control logic unit 126. Additionally, the MS2IAL module may also allow any transaction that is requesting to access a shared memory.

The accelerator 136 may be embodied as any coprocessor, field-programmable gate array (FPGA), application-specific integrated circuit (ASIC), or other hardware- or software-based accelerator that is capable of performing accelerated processing for the compute device 100. The accelerator 136 may access large amounts of memory stored in the memory 134 via the I/O subsystem 124. In particular, the accelerator 136 may perform coherent accesses to the memory 134 via the accelerator port 128 (e.g., an IAL port). In some embodiments, the accelerator 136 may include a cache or other local memory other than the main memory 134. It should be appreciated that, although the compute device 100 depicted in FIG. 1 includes the accelerators 136 connected to the accelerator port 128 of the I/O subsystem 124, an I/O device 142 may be embodied as an accelerator device and may be connected to the root complex 130.

The I/O device 142 may be embodied as an accelerator, a peripheral device (not shown), and/or or other I/O device of the compute device 100. For example, in some embodiments, the peripheral devices may include a touch screen, graphics circuitry, a graphical processing unit (GPU) and/or processor graphics, an audio device, a microphone, a camera, a keyboard, a mouse, a network interface, and/or other input/output devices, interface devices, and/or peripheral devices. The I/O devices 142 that is connected to the I/O subsystem 124 via the root complex 130 may be authenticated as a trusted I/O device to a trust domain using an authentication scheme similar to the PCIe-Sig standard for Universal Serial Bus (USB) device authentication. It should be appreciated that, in some embodiments, the I/O device 142 (i.e. GPU, NIC) may be connected to the accelerator port 128 instead of the root complex 130. In such embodiments, the I/O device may enable additional functionality (e.g., cache coherency and host-visible, device memory).

The compute device 100 also includes the communication subsystem 140, which may be embodied as any communication circuit, device, or collection thereof, capable of enabling communications between the compute device 100 and other remote devices over a computer network (not shown). The communication subsystem 140 may be embodied as any network interface card, network adapter, network controller, host fabric interface, network coprocessor, or other component that connects the compute device 100 to a computer network. The communication subsystem 140 may be configured to use any one or more communication technology (e.g., wired or wireless communications) and associated protocols (e.g., Ethernet, InfiniBand®, Bluetooth®, Wi-Fi®, WiMAX, 3G, 4G LTE, etc.) to effect such communication. In some embodiments, the communication subsystem 140 may form a portion of an SoC and be incorporated along with the processor 120, the memory 134, the I/O subsystem 124, and/or other components of the compute device 100 on a single integrated circuit chip.

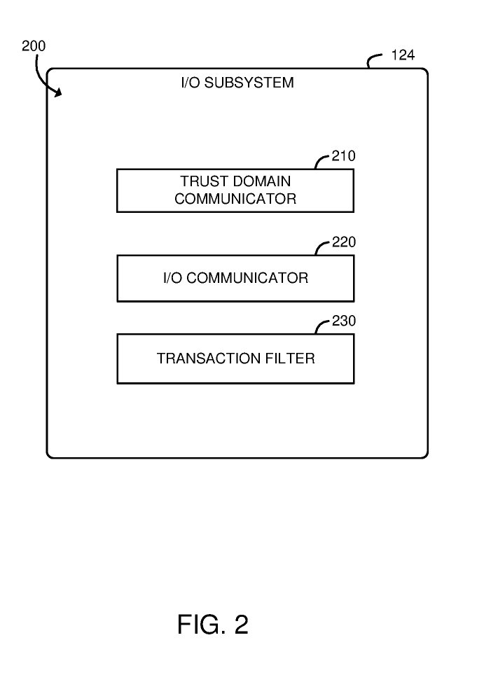

Referring now to FIG. 2, in an illustrative embodiment, the accelerator control logic unit 126 of the compute device 100 establishes an environment 200 during operation. The illustrative environment 200 includes a trust domain communicator 210, an I/O communicator 220, and a transaction filter 230. The various components of the environment 200 may be embodied as hardware, firmware, software, or a combination thereof. As such, in some embodiments, one or more of the components of the environment 200 may be embodied as circuitry or collection of electrical devices (e.g., trust domain communicator circuitry 210, I/O communicator circuitry 220, and/or transaction filter circuitry 230). It should be appreciated that, in such embodiments, one or more of the trust domain communicator circuitry 210, the I/O communicator circuitry 220, and/or the transaction filter circuitry 230 may form a portion of the accelerator control logic unit 126. Additionally, in some embodiments, one or more of the illustrative components may form a portion of another component and/or one or more of the illustrative components may be independent of one another.

The trust domain communicator 210 is configured to communicate with a trust domain to receive one or more private KIDs of the trust domain for trusted I/O devices (e.g., accelerator devices), which is stored in a private KID database. In some embodiments, the trust domain communicator 210 may also be configured to communicate with a trust domain to receive a range of shared KIDs that may be used for untrusted I/O devices. However, it should be appreciated that, in some embodiments, the range of shared KIDs may be received from the processor 120 of the compute device. As described further below, the KID ranges may be used by the transaction filter 230 to determine whether an accelerator device 136 connected to an accelerator port 128 can establish a secure I/O communication with the trust domain (e.g., to access a trust domain memory).

The I/O communicator 220 is configured to communicate with an I/O device (e.g, an accelerator or other I/O device) to receive a DMA transaction generated by the I/O device that requests to access a memory (e.g., the trust domain memory or the memory outside of the trust domain). As discussed above, the DMA transaction includes a key identifier (KID). More specifically, the I/O communicator 220 is configured to determine whether the transaction received from an I/O device that is connected to the accelerator port 128 (via a coherent accelerator link).

The transaction filter 230 is configured to filter DMA transactions received from an accelerator device based on which port the requesting accelerator device is connected to. More specifically, the transaction filter 230 is configured to disable or enable a global attestation during a booting process of the compute device 100 to block or allow transactions received from one or more accelerator devices 136 connected to the accelerator port 128. In the illustrative embodiment, the global attestation is disabled as a default unless it is enabled during the booting process. If the global attestation is disabled, the transaction filter 230 is configured to block all transactions received through the accelerator port 128 that are requesting to access a trust domain memory. To do so, the transaction filter 230 may further be configured to determine whether a key identifier (KID) included in the transaction indicates whether a memory address of the memory access request is to a protected memory of a trust domain or a shared memory. In other words, the transaction filter 230 is configured to allow accesses to a shared memory when the global attestation is disabled.

If the global attestation is enabled during the boot process, the transaction filter 230 is configured to allow all transactions received from one or more accelerator devices 136 to a shared memory and a trust domain memory. For accessing the trust domain memory, the transaction filter 230 is configured to determine whether the KID included in the transaction is within the KID ranges received by the trust domain communicator 210 to determine whether an accelerator device 136 connected to an accelerator port 128 can establish a secure I/O communication with the trust domain (e.g., to access a trust domain memory). If the KID is within the KID ranges, the transaction filter 230 determines that the requesting accelerator device 136 is trusted by a trust domain, and the trust domain communicator 210 allows the accelerator device 136 to access the trust domain memory securely using the MKTME support.

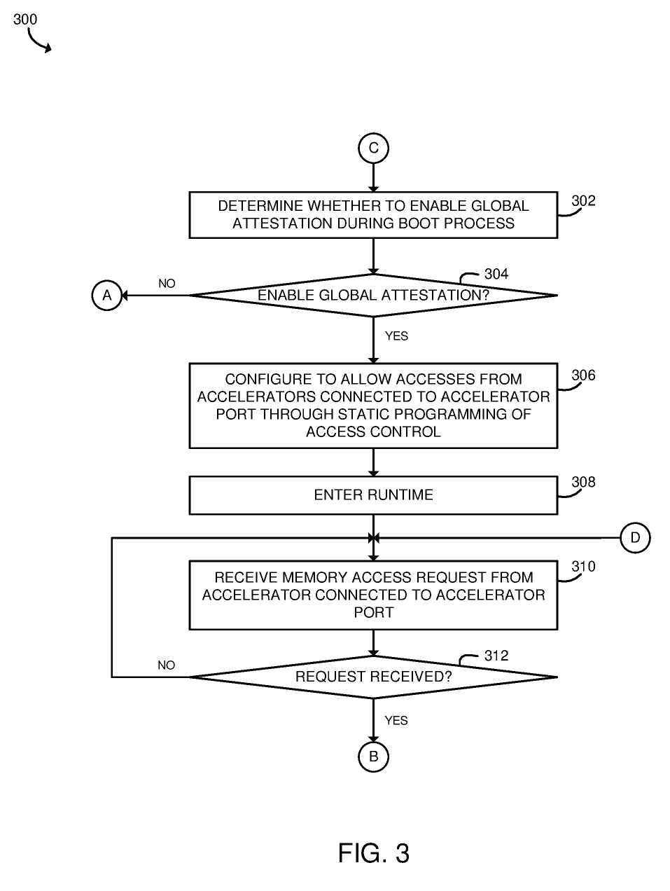

Referring now to FIGS. 3-5, in use, the accelerator control logic unit 126 of the I/O subsystem 124 may execute a method 300 for filtering transactions received from an accelerator 136 connected to an accelerator port 128 of the I/O subsystem 124 requesting to access a trust domain memory. It should be appreciated that, in some embodiments, the operations of the method 300 may be performed by one or more components of the environment 200 of the I/O subsystem 124 of the compute device 100 as shown in FIG. 2. The method 300 begins in block 302, in which the accelerator control logic unit 126 determines whether to enable a global attestation during the boot process of the compute device 100. As discussed above, the accelerator control logic unit 126 may be programmed statically by a trusted agent during the booting process to enable or disable the global attestation to block or allow transactions received from one or more accelerator devices 136 connected to the accelerator port 128. In the illustrative embodiment, the global attestation is disabled as a default unless it is enabled during the boot process. In other words, by default the accelerator control logic unit 126 is configured to block all memory accesses to a trust domain memory that are requested by devices connected to the accelerator port 128.

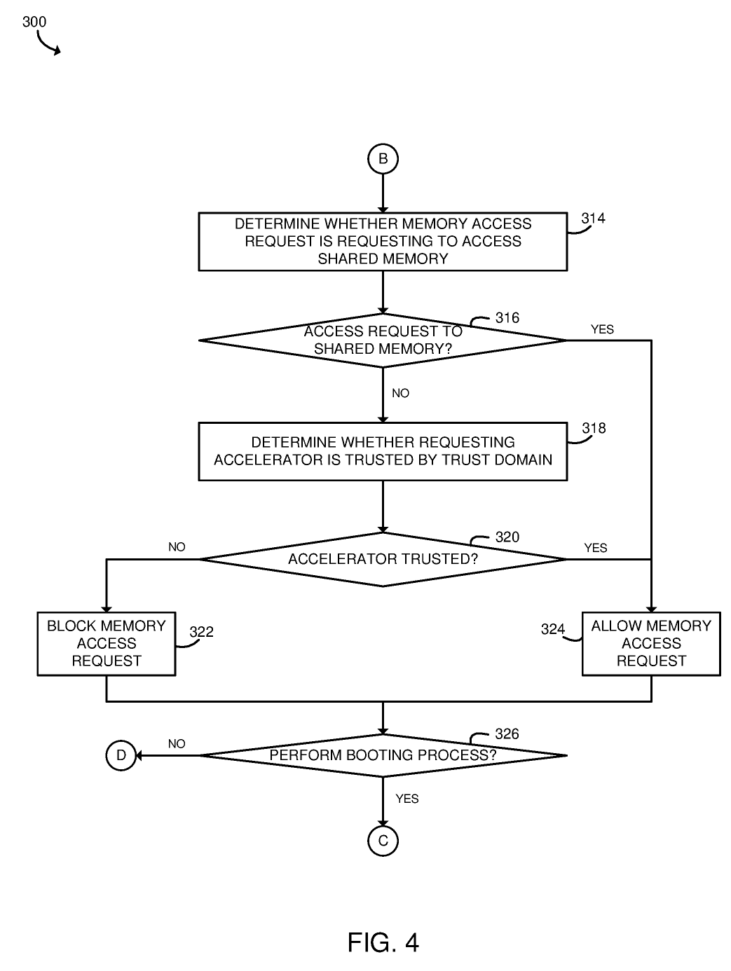

If the accelerator control logic unit 126 determines not to enable the global attestation in block 304, the method 300 skips ahead to block 324 of FIG. 4, which is discussed further below. If, however, the accelerator control logic unit 126 determines to enable the global attestation, the method 300 advances to block 306.

In block 306, the accelerator control logic unit 126 configures to allow memory accesses from accelerator connected to the accelerator port 128 through static programming of the access control. Subsequently, in block 308, the compute device 100 enters runtime after the boot process.

In block 310, the accelerator control logic unit 126 receives a memory access request (e.g., a direct memory access (DMA) transaction) from an accelerator 136 connected to the accelerator port 128 of the I/O device 124. If the accelerator control logic unit 126 determines that a request has not been received in block 312, the method 300 loops back to block 310 to continue waiting for a memory access request. If, however, the accelerator control logic unit 126 determines that a request has been received, the method 300 advances to block 314 of FIG. 4.

In block 314, the accelerator control logic unit 126 determines whether the memory access request received from the accelerator 136 connected to the accelerator port 128 is requesting to access a shared memory. If the connected to the accelerator port 128 determines that the request is requesting to access a shared memory in block 316, the method 300 skips ahead to block 324 to allow the memory access request (i.e., allow the accelerator 136 to access the shared memory). If, however, the connected to the accelerator port 128 determines that the request is not requesting to access a shared memory, the method 300 advances to block 318 to determine whether the requesting accelerator 136 is trusted by a trust domain. If the accelerator control logic unit 126 determines that the accelerator 136 is not trusted in block 320, the accelerator control logic unit 126 blocks the memory access request, as indicated in block 322. If, however, the accelerator control logic unit 126 determines that the accelerator 136 is trusted by a trust domain in block 316, the accelerator control logic unit 126 allows the requested access, as indicated in block 320, to perform secure I/O with the trust domain to access the trust domain memory using MKTME support.

After performing secure I/O, the accelerator control logic unit 126 determines whether the compute device 100 is to perform a booting process, as indicated in block 322. If the accelerator control logic unit 126 determines that the compute device 100 is not to perform the booting process, the method 300 loops back to block 310 to continue receiving a memory access request from an accelerator 136 connected to the accelerator port 128 of the I/O subsystem 124 in a global attestation enabled mode. If, however, the accelerator control logic unit 126 determines that the compute device 100 is to perform the booting process, the method 300 loops back to block 302 to determine whether to disable or re-enable a global attestation.

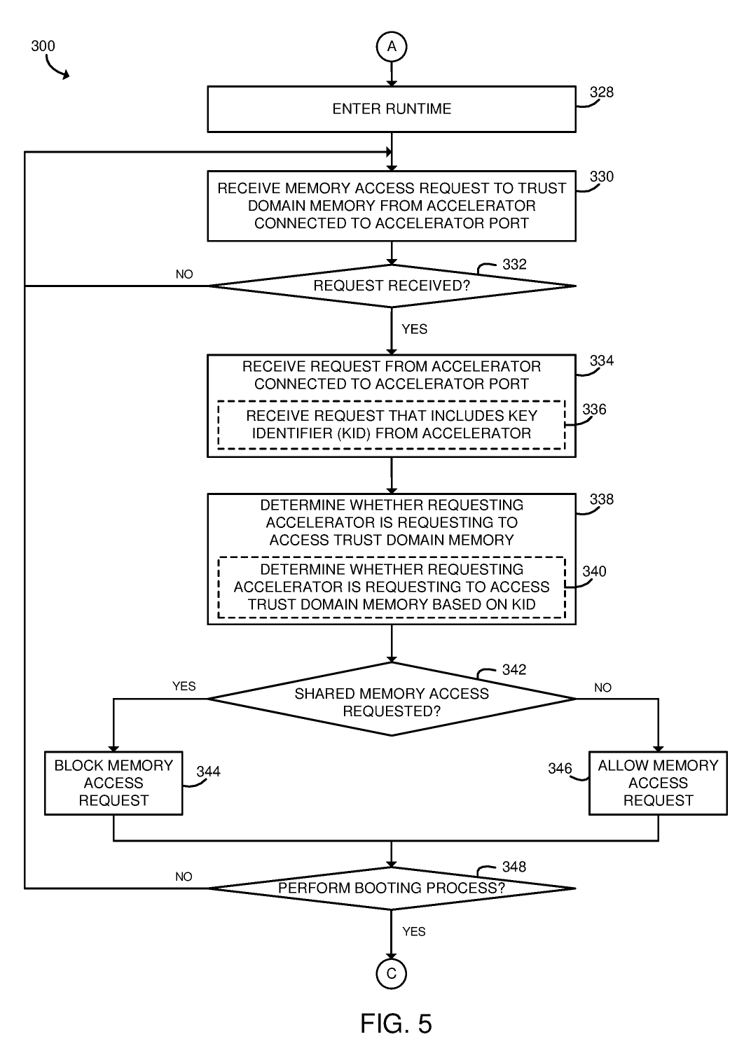

Referring back to block 304, if the accelerator control logic unit 126 determines not to enable the global attestation in block 304, the method 300 skips ahead to block 328 of FIG. 5. In other words, the accelerator control logic unit 126 is configured to block all memory access requests to a trust domain memory (i.e., a private and protected trust domain memory) from a device connected to the accelerator port 128 (e.g., via a coherent accelerator link). Subsequently, in block 328, the compute device 100 enters runtime after the boot process.

In block 330, the accelerator control logic unit 126 receives a memory access request to a trust domain memory from an accelerator 136 connected to the accelerator port 128 of the I/O device 124. If the accelerator control logic unit 126 determines that a request has not been received in block 332, the method 300 loops back to block 330 to continue waiting for a memory access request. If, however, the accelerator control logic unit 126 determines that a request has been received, the method 300 advances to block 334 to receive the request from a requesting accelerator 138 connected to the accelerator port 128. In some embodiments, as indicated in block 336, the request received from the requesting accelerator 136 may include a key identifier (KID), which may be used to identify whether a memory address of the memory access request is to a protected memory of a trust domain or a shared memory. As described above, the accelerator control logic unit 126 may be programmed by the trust domain with one or more private KIDs of the trust domain for trusted I/O devices and a range of shared KIDs that may be used for untrusted I/O devices. Each memory access request (e.g., a DMA transaction) generated by an accelerator may include a key identifier (KID). The KID may be embodied as one or more unused upper address bits or other part of the memory address. Additionally, the accelerator control logic unit 126 may receive a shared KID range assigned by an operating system, trust domain, or other entity that may be used for untrusted I/O devices.

Subsequently, in block 338, the accelerator control logic unit 126 determines whether the requesting accelerator is requesting to access a protected or private trust domain memory (i.e., not a shared memory). For example, in some embodiments, the accelerator control logic unit 126 may determine whether the requesting accelerator is requesting to access a trust domain memory based on a KID indicated in the request, as indicated in block 340.

If the accelerator control logic unit 126 determines that the requesting accelerator is requesting to access a trust domain memory in block 342, the accelerator control logic unit 126 blocks the memory access request, as indicated in block 344. If, however, the accelerator control logic unit 126 determines that the requesting accelerator is not requesting to access a trust domain memory, the accelerator control logic unit 126 allows the memory access request to a corresponding shared memory, as indicated in block 346.

Subsequently, in block 348, the accelerator control logic unit 126 determines whether the compute device 100 is to perform a booting process. If the accelerator control logic unit 126 determines that the compute device 100 is not to perform the booting process, the method 300 loops back to block 330 to continue receiving a memory access request from an accelerator 136 connected to the accelerator port 128 of the I/O subsystem 124 in a global attestation disabled mode. If, however, the accelerator control logic unit 126 determines that the compute device 100 is to perform the booting process, the method 300 loops back to block 302 to determine whether to enable a global attestation.

### EXAMPLES

Illustrative examples of the technologies disclosed herein are provided below. An embodiment of the technologies may include any one or more, and any combination of, the examples described below.

Example 1 includes a compute device for filtering transactions, the compute device comprising an accelerator device; and an I/O subsystem having an accelerator port, the I/O subsystem is to determine whether to enable a global attestation during a boot process of the compute device; receive a transaction from the accelerator device connected to the accelerator port via a coherent accelerator link; and filter the transaction based on a determination of whether to enable the global attestation.

Example 2 includes the subject matter of Example 1, and wherein to receive the transaction comprises to receive, in response to a determination not to enable the global attestation, a transaction from the accelerator device connected to the accelerator port.

Example 3 includes the subject matter of any of Examples 1 and 2, and wherein the I/O subsystem is further to determine whether the transaction requires to access a trust domain memory.

Example 4 includes the subject matter of any of Examples 1-3, and wherein the I/O subsystem is further to allow, in response to a determination that the transaction is not requesting to access the trust domain memory, the transaction.

Example 5 includes the subject matter of any of Examples 1-4, and wherein the I/O subsystem is further to block, in response to a determination that the transaction is requesting to access the trust domain memory, the transaction.

Example 6 includes the subject matter of any of Examples 1-5, and wherein to determine whether the transaction requires to access the trust domain memory comprises to determine whether a key identifier indicated in the transaction is a private key identifier of a trust domain.

Example 7 includes the subject matter of any of Examples 1-6, and wherein determining whether the transaction requires to access the trust domain memory comprises determining whether a key identifier indicated in the transaction is within a shared key identifier range to be used for untrusted accelerator devices.

Example 8 includes the subject matter of any of Examples 1-7, and wherein to receive the transaction comprises to receive, in response to a determination to enable the global attestation, a transaction from an accelerator device connected to an accelerator port of the I/O subsystem.

Example 9 includes the subject matter of any of Examples 1-8, and wherein the I/O subsystem is further to determine whether the accelerator device is trusted by a trust domain, wherein to filter the transaction comprises to allow, in response to a determination that the accelerator device is trusted by the trust domain, the transaction to a trust domain memory.

Example 10 includes the subject matter of any of Examples 1-9, and wherein the transaction is a direct memory access transaction.

Example 11 includes a method for filtering transactions, the method comprising determining, by an I/O subsystem of a compute device, whether to enable a global attestation during a boot process of the compute device; receiving, by the I/O subsystem, a transaction from an accelerator device connected to an accelerator port of the I/O subsystem via a coherent accelerator link; and filtering, by the I/O subsystem, the transaction based on a determination of whether to enable the global attestation.

Example 12 includes the subject matter of Example 11, and wherein receiving the transaction comprises receiving, in response to determining not to enable the global attestation and by the I/O subsystem, a transaction from an accelerator device connected to an accelerator port of the I/O subsystem.

Example 13 includes the subject matter of any of Examples 11 and 12, and further including determining, by the I/O subsystem, whether the transaction requires to access a trust domain memory.

Example 14 includes the subject matter of any of Examples 11-13, and wherein filtering the transaction comprises allowing, in response to determining that the transaction is not requesting to access the trust domain memory and by the I/O subsystem, the transaction.

Example 15 includes the subject matter of any of Examples 11-14, and wherein blocking, in response to determining that the transaction is requesting to access the trust domain memory and by the I/O subsystem, the transaction.

Example 16 includes the subject matter of any of Examples 11-15, and wherein determining whether the transaction requires to access the trust domain memory comprises determining, by the I/O subsystem, whether a key identifier indicated in the transaction is a private key identifier of a trust domain.

Example 17 includes the subject matter of any of Examples 11-16, and wherein determining whether the transaction requires to access the trust domain memory comprises determining, by the I/O subsystem, whether a key identifier indicated in the transaction is within a shared key identifier range to be used for untrusted accelerator devices.

Example 18 includes the subject matter of any of Examples 11-17, and wherein receiving the transaction comprises receiving, in response to determining to enable the global attestation and by the I/O subsystem, a transaction from an accelerator device connected to an accelerator port of the I/O subsystem.

Example 19 includes the subject matter of any of Examples 11-18, and further including determining, by the I/O subsystem, whether the accelerator device is trusted by a trust domain, wherein filtering the transaction comprises allowing, in response to determining that the accelerator device is trusted by the trust domain and by the I/O subsystem, the transaction to a trust domain memory.

Example 20 includes one or more machine-readable storage media comprising a plurality of instructions stored thereon that, in response to being executed, cause a compute device to determine whether to enable a global attestation during a boot process of the compute device; receive a transaction from an accelerator device connected to an accelerator port of the I/O subsystem of the compute device via a coherent accelerator link; and filter the transaction based on a determination of whether to enable the global attestation.

1. A compute device for filtering transactions, the compute device comprising:
an accelerator device; and
an I/O subsystem having an accelerator port, the I/O subsystem is to:
determine whether to enable a global attestation during a boot process of the compute device;
receive a transaction from the accelerator device connected to the accelerator port via a coherent accelerator link; and
filter the transaction based on a determination of whether to enable the global attestation.

2. The compute device of claim 1, wherein to receive the transaction comprises to receive, in response to a determination not to enable the global attestation, a transaction from the accelerator device connected to the accelerator port.

3. The compute device of claim 2, wherein the I/O subsystem is further to determine whether the transaction requires to access a trust domain memory.

4. The compute device of claim 3, wherein the I/O subsystem is further to allow, in response to a determination that the transaction is not requesting to access the trust domain memory, the transaction.

5. The compute device of claim 3, wherein the I/O subsystem is further to block, in response to a determination that the transaction is requesting to access the trust domain memory, the transaction.

6. The compute device of claim 3, wherein to determine whether the transaction requires to access the trust domain memory comprises to determine whether a key identifier indicated in the transaction is a private key identifier of a trust domain.

7. The compute device of claim 3, wherein determining whether the transaction requires to access the trust domain memory comprises determining whether a key identifier indicated in the transaction is within a shared key identifier range to be used for untrusted accelerator devices.

8. The compute device of claim 1, wherein to receive the transaction comprises to receive, in response to a determination to enable the global attestation, a transaction from an accelerator device connected to an accelerator port of the I/O subsystem.

9. The compute device of claim 8, wherein the I/O subsystem is further to determine whether the accelerator device is trusted by a trust domain,
wherein to filter the transaction comprises to allow, in response to a determination that the accelerator device is trusted by the trust domain, the transaction to a trust domain memory.

10. The compute device of claim 1, wherein the transaction is a direct memory access transaction.

11. A method for filtering transactions, the method comprising:
determining, by an I/O subsystem of a compute device, whether to enable a global attestation during a boot process of the compute device;
receiving, by the I/O subsystem, a transaction from an accelerator device connected to an accelerator port of the I/O subsystem via a coherent accelerator link; and
filtering, by the I/O subsystem, the transaction based on a determination of whether to enable the global attestation.

12. The method of claim 11, wherein receiving the transaction comprises receiving, in response to determining not to enable the global attestation and by the I/O subsystem, a transaction from an accelerator device connected to an accelerator port of the I/O subsystem.

13. The method of claim 12, further comprising determining, by the I/O subsystem, whether the transaction requires to access a trust domain memory.

14. The method of claim 13, wherein filtering the transaction comprises allowing, in response to determining that the transaction is not requesting to access the trust domain memory and by the I/O subsystem, the transaction.

15. The method of claim 13, wherein blocking, in response to determining that the transaction is requesting to access the trust domain memory and by the I/O subsystem, the transaction.

16. The method of claim 13, wherein determining whether the transaction requires to access the trust domain memory comprises determining, by the I/O subsystem, whether a key identifier indicated in the transaction is a private key identifier of a trust domain.

17. The method of claim 13, wherein determining whether the transaction requires to access the trust domain memory comprises determining, by the I/O subsystem, whether a key identifier indicated in the transaction is within a shared key identifier range to be used for untrusted accelerator devices.

18. The method of claim 12, wherein receiving the transaction comprises receiving, in response to determining to enable the global attestation and by the I/O subsystem, a transaction from an accelerator device connected to an accelerator port of the I/O subsystem.

19. The method of claim 18, further comprising determining, by the I/O subsystem, whether the accelerator device is trusted by a trust domain, wherein filtering the transaction comprises allowing, in response to determining that the accelerator device is trusted by the trust domain and by the I/O subsystem, the transaction to a trust domain memory.

20. One or more machine-readable storage media comprising a plurality of instructions stored thereon that, in response to being executed, cause a compute device to:
determine whether to enable a global attestation during a boot process of the compute device;
receive a transaction from an accelerator device connected to an accelerator port of the I/O subsystem of the compute device via a coherent accelerator link; and
filter the transaction based on a determination of whether to enable the global attestation.
